(19) United States
(12) Patent Application Publication
(10) Pub. No.: US 2007/0185868 A1
(43) Pub. Date: Aug. 9, 2007

(54) Method and apparatus for semantic search of schema repositories

(76) Inventors: Mary Ann Roth, San Jose, CA (US); Gauri Shah, Santa Clara, CA (US); Tanveer Fathima Syeda-Mahmood, Cupertino, CA (US); Willi Urban, Gaeufelden (DE); Lingling Yan, San Jose, CA (US)

Correspondence Address: IP AUTHORITY, LLC;RAMRAJ SOUNDARARAJAN, 9435 LORTON MARKET STREET #801, LORTON, VA, 22079, US

(21) Appl. No.: 11/349,081

(22) Filed: Feb. 8, 2006

(51) Int. Cl. G06F 17/30

(52) U.S. Cl. 707/6

(57) ABSTRACT

Mechanisms for searching XML repositories for semantically related schemas from a variety of structured metadata sources, including web services, XSD documents and relational tables, in databases and Internet applications. A search is formulated as a problem of computing a maximum matching in pairwise bipartite graphs formed from query and repository schemas. The edges of such a bipartite graph capture the semantic similarity between corresponding attributes of the schema based on their name and type semantics. Tight upper and lower bounds are also derived on the maximum matching that can be used for fast ranking of matchings whilst still maintaining specified levels of precision and recall. Schema indexing is performed by ‘attribute hashing’, in which matching schemas of a database are found by indexing using query attributes, performing lower bound computations for maximum matching and recording peaks in the resulting histogram of hits.

### BACKGROUND OF THE INVENTION

1. Field of Invention

The present invention relates generally to the field of searching repositories for semantically related schemas. More specifically, the present invention is related to mechanisms for searching XML repositories for semantically related schemas representing structured metadata.

2. Discussion of Prior Art

XML is fast becoming the de facto standard for representing structured metadata in databases and Internet applications. It is now possible to express several kinds of metadata such as relational schemas, business objects or web services through XML schemas. As XML starts to be used more ubiquitously in the industry, large metadata repositories are being constructed ranging from business object repositories, UDDIs (Universal Description Discovery and Interaction) to general metadata repositories. This has given rise to the need for efficient search mechanisms for the search of such XML repositories in several application domains, for example, in business process modeling, analysts want to search for appropriate services to help compose their business process flows. In data warehousing, warehousing specialists would like more automatic ways to identify related schemas for merging than the current laborious GUI-directed processes offered by warehousing tools. Finally, an increasing number of organizations are putting their business competencies as a collection of web services. It is conceivable that other users could integrate them to create new value-added services in ways that were not anticipated by their original developers. This would require searching through repositories such as UDDI for service schemas with capabilities matching the desired task description.

Much of the work on XML query and search has stemmed form the publishing and database communities, mostly for the needs of business applications. Recently the information retrieval community began investigating the XML search issue to answer information discovery needs. Following this trend, an approach was earlier presented where ‘XML fragments’ were used to search a collection of schemas using an extension of the vector space model, see “Searching XML Documents Using XML Fragments”, Carmel, D., Maarek, M., Mandelbrod, Y., Mass, Y. and Soffer, A., Proceedings of the 26^{th} Annual International ACM SIGIR, pp 151-158, Toronto, Canada, July 2003. Full-text searches for phrases (a sequence of words) rather than substrings has also been proposed in the latest XQuery standard, see “XQuery 1.0: An XML Query Language”, http://www.w3.org/TR/2004/WD-xquery-20041029.

The notion of search through repositories has also been popular in web services. Web service schemas are published to a public or private UDDI registry. The design of UDDI allows simple forms of searching and allows trading partners to publish data about themselves and their advertised web services to voluntarily provide categorization data. Several companies are trying to put forward UDDI registries, including HP and IBM, see IBM Developer Works http://www-130.ibm.com/developerworks.

The three predominant ways of searching metadata repositories are:—(1) visual browsing through categories; (2) keyword searches, and (3) XPath expressions. Visual navigation relies on a priori categorization of the services as in UDDIs, a laborious and inexact process where a misclassification can lead to a false negative or a false positive. Keyword-base search techniques use information retrieval methods to do a full-text search of the underlying repository. Full-text search of XML documents based on a few keywords, however, can retrieve a number of false positives since the same keywords may occur in different XML schemas possibly within a different context and structure. Finally, XQuery specifies searching through XPath expressions that capture the structure of the XML documents during navigation and search. Whilst such structured queries can find exact matchings, they are more difficult to use for similarity searches. Further, they require a priori knowledge of the schemas to construct path queries.

The problem of automatically finding semantic relationships between schemas has also been recently addressed by a number of database researchers. See, for example, “Generic Schema Matching with Cupid”, Madhavan, J., Bernstein, P. A. and Rahm, E., Proceedings of the 27^{th} International conference on Very Large Databases, Rome, Italy, September 2001; “Semantic Integration of Heterogeneous Information Sources”, Bergamaschi, S., Castano, S., Vincini, M. and Beneventano, D., Data and Knowledge Engineering, volume 36, number 3, pp 215-249, March 2001; “Identifying Attribute Correspondences in Heterogeneous Databases Using Neural Networks”, Li, W.-S. and Clifton, C., Data and Knowledge Engineering, volume 33, number 1, pp 49-84, April 2000; “Reconciling Schemas of Disparate Data Sources: A Machine-Learned Approach”, Doan, A., Domingos, P. and Halevy, A. Y., Proceedings of the ACM SIGMOD, Santa Barbara, Calif., USA, May 2001; “A System for Flexible combination of Schema Matching Approaches”, Do, H.-H. and Rahm, E., Proceedings of the 28^{th} International conference on Very Large Databases, Hong Kong, August 2002; “Learning to Map Between Ontologies on the Semantic Web”, Doan, A., Madhavan, J., Domingos, P. and Halevy, A., Proceedings of the 11^{th} International World Wide Web conference, pp 59-66, Hawaii, May 2002; “A Survey of Approaches in Automatic Schema Matching”, Rahm, E. and Bernstein, P. A., VLDB Journal, volume 10, number 4, pp 334-350, 2001. Whilst previous work has focused on pair-wise schema matching, the problem of searching large schema repositories using semantic schema matching approaches has not been addressed. For large schema repositories, it is impractical to use approaches such as similarity flooding, which involves detailed graph traversal, see “A Versatile Graph Matching Algorithm and Its Application to Schema Matching”, Melnik, S., Garcia-Molina, H. and Rahm, E., Proceedings of the 18^{th} International Conference on Data, pp 117-128, San Jose, Calif., USA, March 2002.

Whatever the precise merits, features, and advantages of the above cited references, none of them achieves or fulfills the purposes of the present invention.

### SUMMARY OF THE INVENTION

With XML fast becoming the de facto standard for representing structured metadata in databases and Internet applications, an urgent need has arisen for mechanisms for searching XML repositories for semantically related schemas. The present invention enables searching of semantically related schemas from a variety of metadata sources including web services, XSD documents and relational tables. More specifically, a search is formulated as a problem of computing a maximum matching in pairwise bipartite graphs formed from query and repository schemas. The edges of such a bipartite graph capture the semantic similarity between corresponding attributes of the schema based on their name and type semantics. Tight upper and lower bounds are also derived on the maximum matching that can be used for fast ranking of matchings whilst still maintaining specified levels of precision and recall. The present invention also includes a technique for schema indexing called attribute hashing, in which matching schemas of a database are found by indexing using query attributes, performing lower bound computations for maximum matching and recording peaks in the resulting histogram of hits.

In a first aspect of the invention, the invention includes a method of finding repository schema similar to a query schema in repositories of metadata via semantic search, including the steps of parsing the query schema to extract query words, parsing at least one of the repository schema to extract repository words, determining a match if a query word matches a repository word, retaining each repository schema in which at least one match is found, establishing a semantic matching for each retained repository schema in which a given proportion of the query words matches a repository word, ranking each semantic matching and returning each retained repository schema as a candidate if the rank is greater than a predetermined value.

In a second aspect of the invention, the invention includes a method of finding repository schema similar to a query schema in repositories of metadata via semantic search, including the steps of parsing the query schema to extract query words, parsing at least one of the repository schema to extract repository words, determining a match if a query word matches a repository word, retaining each repository schema in which at least one match is found, establishing a semantic matching for each retained repository schema in which a given proportion of the query words matches a repository word, ranking each semantic matching, where ranking further includes the steps of finding a lower bound on the matching and ranking each semantic matching based on the lower bound, and returning each retained repository schema as a candidate if the rank is greater than a predetermined value.

In a third aspect of the invention, the invention includes a method of finding repository schema similar to a query schema in repositories of metadata via semantic search, including the steps of parsing the query schema to extract query words, parsing at least one of the repository schema to extract repository words, determining a match if a query word matches a repository word, retaining each repository schema in which at least one match is found, establishing a semantic matching for each retained repository schema in which a given proportion of the query words matches a repository word, ranking each semantic matching, where ranking further includes the steps of finding a lower bound on the matching, ranking each semantic matching based on the lower bound, generating a histogram of frequency of occurrence of the query words in each retained repository schema and discarding the retained repository schema unless the retained repository schema corresponds to a maxima in the histogram, and returning each retained repository schema as a candidate if the rank is greater than a predetermined value.

In a fourth aspect of the invention, the invention includes a method of finding repository schema similar to a query schema in repositories of metadata via semantic search, including the steps of parsing the query schema to extract query words, parsing at least one of the repository schema to extract repository words, creating a hash table, indexing the hash table for each query word, determining a match if a query word matches a repository word, retaining each repository schema in which at least one match is found, establishing a semantic matching for each retained repository schema in which a given proportion of the query words matches a repository word, ranking each semantic matching and returning each retained repository schema as a candidate if the rank is greater than a predetermined value.

In a fifth aspect of the invention, the invention includes a method of finding repository schema similar to a query schema in repositories of metadata via semantic search, including the steps of parsing the query schema to extract query words, parsing at least one of the repository schema to extract repository words, determining a match if substantially two thirds of the query words match a repository word, retaining each repository schema in which at least one match is found, establishing a semantic matching for each retained repository schema in which a given proportion of the query words matches a repository word, ranking each semantic matching and returning each retained repository schema as a candidate if the rank is greater than a predetermined value.

In a sixth aspect of the invention, the invention includes a method of finding repository schema similar to a query schema in repositories of metadata via semantic search, including the steps of parsing the query schema to extract query words, parsing at least one of the repository schema to extract repository words, tokenizing the query words, tokenizing the repository words, extracting synonyms from the tokenized repository words by employing a thesaurus to expand the tokenized repository words, determining a match if a tokenized query word matches a tokenized and expanded repository word, retaining each repository schema in which at least one match is found, establishing a semantic matching for each retained repository schema in which a given proportion of the query words matches a repository word, ranking each semantic matching and returning each retained repository schema as a candidate if the rank is greater than a predetermined value.

In a seventh aspect of the invention, the invention includes a method of finding repository schema similar to a query schema in repositories of metadata via semantic search, including the steps of parsing the query schema to extract query words, parsing at least one of the repository schema to extract repository words, tokenizing the query words, tokenizing the repository words, extracting synonyms from the tokenized repository words by employing a thesaurus to expand the tokenized repository words, tagging parts of speech in the query words and the repository words, determining a match if a tokenized and tagged query word matches a tokenized, expanded and tagged repository word, retaining each repository schema in which at least one match is found, establishing a semantic matching for each retained repository schema in which a given proportion of the query words matches a repository word, ranking each semantic matching and returning each retained repository schema as a candidate if the rank is greater than a predetermined value.

In an eighth aspect of the invention, the invention includes a computer readable medium having computer executable instructions for performing steps to find repository schema similar to a query schema in repositories of metadata via semantic search, including computer readable program code parsing the query schema to extract query words, computer readable program code parsing at least one of the repository schema to extract repository words, computer readable program code determining a match if a given proportion of the query words match a repository word, computer readable program code retaining each repository schema in which at least one match is found, computer readable program code establishing a semantic matching for each retained repository schema in which a given proportion of the query words matches a repository word, computer readable program code ranking each semantic, and computer readable program code returning each retained repository schema as a candidate if the rank of the semantic matching is greater than a predetermined value.

In an ninth aspect of the invention, the invention includes a computer readable medium having computer executable instructions for performing steps to find repository schema similar to a query schema in repositories of metadata via semantic search, including computer readable program code parsing the query schema to extract query words, computer readable program code parsing at least one of the repository schema to extract repository words, computer readable program code determining a match if a given proportion of the query words match a repository word, computer readable program code retaining each repository schema in which at least one match is found, computer readable program code establishing a semantic matching for each retained repository schema in which a given proportion of the query words matches a repository word, computer readable program code ranking each semantic matching, where the computer readable program code ranking each semantic matching further includes computer readable program code finding a lower bound on the matching and computer readable program code ranking each semantic matching based on the lower bound of the matching, and computer readable program code returning each retained repository schema as a candidate if the rank of the semantic matching is greater than a predetermined value.

In an tenth aspect of the invention, the invention includes a computer readable medium having computer executable instructions for performing steps to find repository schema similar to a query schema in repositories of metadata via semantic search, including computer readable program code parsing the query schema to extract query words, computer readable program code parsing at least one of the repository schema to extract repository words, computer readable program code determining a match if a given proportion of the query words match a repository word, computer readable program code retaining each repository schema in which at least one match is found, computer readable program code establishing a semantic matching for each retained repository schema in which a given proportion of the query words matches a repository word, computer readable program code ranking each semantic matching, where the computer readable program code ranking each semantic matching further includes computer readable program code finding a lower bound on the matching, computer readable program code ranking each semantic matching based on the lower bound of the matching, computer readable program code generating a histogram of frequency of occurrence of the query words in each retained repository schema and computer readable program code discarding the retained repository schema unless the retained repository schema corresponds to a maxima in the histogram, and computer readable program code returning each retained repository schema as a candidate if the rank of the semantic matching is greater than a predetermined value.

In an eleventh aspect of the invention, the invention includes a computer readable medium having computer executable instructions for performing steps to find repository schema similar to a query schema in repositories of metadata via semantic search, including computer readable program code parsing the query schema to extract query words, computer readable program code parsing at least one of the repository schema to extract repository words, computer readable program code creating a hash table, computer readable program code indexing the hash table for each query word, computer readable program code determining a match if a given proportion of the query words match a repository word, computer readable program code retaining each repository schema in which at least one match is found, computer readable program code establishing a semantic matching for each retained repository schema in which a given proportion of the query words matches a repository word, computer readable program code ranking each semantic, and computer readable program code returning each retained repository schema as a candidate if the rank of the semantic matching is greater than a predetermined value.

In an twelfth aspect of the invention, the invention includes a computer readable medium having computer executable instructions for performing steps to find repository schema similar to a query schema in repositories of metadata via semantic search, including computer readable program code parsing the query schema to extract query words, computer readable program code parsing at least one of the repository schema to extract repository words, computer readable program code determining a match if substantially two thirds of the query words match a repository word, computer readable program code retaining each repository schema in which at least one match is found, computer readable program code establishing a semantic matching for each retained repository schema in which a given proportion of the query words matches a repository word, computer readable program code ranking each semantic, and computer readable program code returning each retained repository schema as a candidate if the rank of the semantic matching is greater than a predetermined value.

In an thirteenth aspect of the invention, the invention includes a computer readable medium having computer executable instructions for performing steps to find repository schema similar to a query schema in repositories of metadata via semantic search, including computer readable program code parsing the query schema to extract query words, computer readable program code parsing at least one of the repository schema to extract repository words, computer readable program code tokenizing the query words, computer readable program code tokenizing the repository words, computer readable program code extracting synonyms from the tokenized repository words by employing a thesaurus to expand the tokenized repository words, computer readable program code determining a match if a given proportion of the tokenized query words match a tokenized and expanded repository word, computer readable program code retaining each repository schema in which at least one match is found, computer readable program code establishing a semantic matching for each retained repository schema in which a given proportion of the query words matches a repository word, computer readable program code ranking each semantic, and computer readable program code returning each retained repository schema as a candidate if the rank of the semantic matching is greater than a predetermined value.

In an fourteenth aspect of the invention, the invention includes a computer readable medium having computer executable instructions for performing steps to find repository schema similar to a query schema in repositories of metadata via semantic search, including computer readable program code parsing the query schema to extract query words, computer readable program code parsing at least one of the repository schema to extract repository words, computer readable program code tokenizing the query words, computer readable program code tokenizing the repository words, computer readable program code extracting synonyms from the tokenized repository words by employing a thesaurus to expand the tokenized repository words, computer readable program code tagging parts of speech in the tokenized query words and the tokenized and expanded repository words, computer readable program code determining a match if a given proportion of the tokenized and tagged query words match a tokenized, expanded and tagged repository word, computer readable program code retaining each repository schema in which at least one match is found, computer readable program code establishing a semantic matching for each retained repository schema in which a given proportion of the query words matches a repository word, computer readable program code ranking each semantic, and computer readable program code returning each retained repository schema as a candidate if the rank of the semantic matching is greater than a predetermined value.

In an fifteenth aspect of the invention, the invention includes an apparatus for finding repository schema similar to a query schema in repositories of metadata via semantic search, including means for parsing the query schema to extract query words, means for parsing at least one of the repository schema to extract repository words, means for determining a match if a given proportion of the query words match a repository word, means for retaining each repository schema in which at least one match is found, means for establishing a semantic matching for each retained repository schema in which a given proportion of the query words matches a repository word, means for ranking each semantic matching, and means for returning each retained repository schema as a candidate if the rank of the semantic matching is greater than a predetermined value.

In an sixteenth aspect of the invention, the invention includes an apparatus for finding repository schema similar to a query schema in repositories of metadata via semantic search, including means for parsing the query schema to extract query words, means for parsing at least one of the repository schema to extract repository words, means for determining a match if a given proportion of the query words match a repository word, means for retaining each repository schema in which at least one match is found, means for establishing a semantic matching for each retained repository schema in which a given proportion of the query words matches a repository word, means for ranking each semantic matching, where the means for ranking each semantic matching further includes means for finding a lower bound on the matching and means for ranking each semantic matching based on the lower bound of the matching, and means for returning each retained repository schema as a candidate if the rank of the semantic matching is greater than a predetermined value.

In an seventeenth aspect of the invention, the invention includes an apparatus for finding repository schema similar to a query schema in repositories of metadata via semantic search, including means for parsing the query schema to extract query words, means for parsing at least one of the repository schema to extract repository words, means for determining a match if a given proportion of the query words match a repository word, means for retaining each repository schema in which at least one match is found, means for establishing a semantic matching for each retained repository schema in which a given proportion of the query words matches a repository word, means for ranking each semantic matching, where the means for ranking each semantic matching further includes means for finding a lower bound on the matching, means for ranking each semantic matching based on the lower bound of the matching, means for generating a histogram of frequency of occurrence of the query words in each retained repository schema, and computer readable program code discarding the retained repository schema unless the retained repository schema corresponds to a maxima in the histogram, and means for returning each retained repository schema as a candidate if the rank of the semantic matching is greater than a predetermined value.

In an eighteenth aspect of the invention, the invention includes an apparatus for finding repository schema similar to a query schema in repositories of metadata via semantic search, including means for parsing the query schema to extract query words, means for parsing at least one of the repository schema to extract repository words, means for creating a hash table, means for indexing the hash table for each query word, means for determining a match if a given proportion of the query words match a repository word, means for retaining each repository schema in which at least one match is found, means for establishing a semantic matching for each retained repository schema in which a given proportion of the query words matches a repository word, means for ranking each semantic matching, and means for returning each retained repository schema as a candidate if the rank of the semantic matching is greater than a predetermined value.

In an nineteenth aspect of the invention, the invention includes an apparatus for finding repository schema similar to a query schema in repositories of metadata via semantic search, including means for parsing the query schema to extract query words, means for parsing at least one of the repository schema to extract repository words, means for determining a match if substantially two thirds of the query words match a repository word, means for retaining each repository schema in which at least one match is found, means for establishing a semantic matching for each retained repository schema in which a given proportion of the query words matches a repository word, means for ranking each semantic matching, and means for returning each retained repository schema as a candidate if the rank of the semantic matching is greater than a predetermined value.

In an twentieth aspect of the invention, the invention includes an apparatus for finding repository schema similar to a query schema in repositories of metadata via semantic search, including means for parsing the query schema to extract query words, means for parsing at least one of the repository schema to extract repository words, means for tokenizing the query words, means for tokenizing the repository words, means for extracting synonyms from the tokenized repository words by employing a thesaurus to expand the tokenized repository words, means for determining a match if a given proportion of the tokenized query words match a tokenized and expanded repository word, means for retaining each repository schema in which at least one match is found, means for establishing a semantic matching for each retained repository schema in which a given proportion of the query words matches a repository word, means for ranking each semantic matching, and means for returning each retained repository schema as a candidate if the rank of the semantic matching is greater than a predetermined value.

In an twenty-first aspect of the invention, the invention includes an apparatus for finding repository schema similar to a query schema in repositories of metadata via semantic search, including means for parsing the query schema to extract query words, means for parsing at least one of the repository schema to extract repository words, means for tokenizing the query words, means for tokenizing the repository words, means for extracting synonyms from the tokenized repository words by employing a thesaurus to expand the tokenized repository words, means for tagging parts of speech in the tokenized query words and the tokenized repository words, means for determining a match if a given proportion of the tokenized and tagged query words match a tokenized, expanded and tagged repository word, means for retaining each repository schema in which at least one match is found, means for establishing a semantic matching for each retained repository schema in which a given proportion of the query words matches a repository word, means for ranking each semantic matching, and means for returning each retained repository schema as a candidate if the rank of the semantic matching is greater than a predetermined value.

### BRIEF DESCRIPTION OF THE DRAWINGS

FIG. 1 illustrates upper and lower bounds on matching.

FIG. 2 illustrates issues in schema matching.

FIG. 3A illustrates an original bipartite graph of upper and lower bounds in maximum matching.

FIG. 3B illustrates operations in lower bound computation, retaining only one outgoing or incoming edge per node.

FIG. 3C illustrates the maximum matching for the graph of FIG. 3A.

FIG. 4 illustrates average precision using full-text indexing, LCS matching and semantic matching.

FIG. 5 illustrates average recall using full-text indexing, LCS matching and semantic matching.

FIG. 6 illustrates average precision versus recall using full-text indexing, LCS matching and semantic matching.

FIG. 7 illustrates the time taken to index a database and query it using full-text indexing, LCS matching and semantic matching.

FIG. 8 illustrates sample relational database schema.

FIG. 9 illustrates sample WSDL schema.

FIG. 10 illustrates matching WSDL schema.

FIG. 11 illustrates sample XML schema.

FIG. 12 illustrates a system according to a preferred embodiment of the invention.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

The requirements for a search engine for XML repositories will be discussed below, and a fast and efficient search mechanism for these repositories will be described. More specifically, the problem of querying XML repositories will be addressed. Such schemas are available in many practical situations, either as skeletal designs made by analysts whilst looking for matching services, or obtained from another data source as in data warehousing. Please note that although the algorithms described are for XML schemas, the same techniques can be applied to any kind of repository, specifically including relational databases.

The problem of finding matching schemas from repositories is herein formulated as the problem of computing a maximum matching in pairwise bipartite graphs formed from query and repository attributes. The term ‘attribute’ is used throughout herein to refer to multi-term words in schema that reflect schema content rather than tag information. Thus the operation name in a service would be an attribute, whilst the word ‘operation’ would be considered to be a tag type. The edges of the bipartite graph capture the similarity between corresponding attributes in the schema. To ensure meaningful matchings and to allow for situations where schemas use related but not identical words to describe related entities, both name and type semantics are used in modeling the similarity between attributes. Since detailed graph matching is computing intensive, a preferred embodiment of the present invention uses upper and lower bounds on the size of the matching to prune candidate schemas. Tight upper and lower bounds on the maximum matching that can be used are derived for fast ranking of matches whilst still maintaining specified levels of precision and recall. A technique for schema indexing called ‘attribute hashing’ is also developed. Attribute hashing involves building a semantic hash table for recording information about indexed words through synonym keys. The matching schemas of the database are then found by indexing the hash table using query attributes, performing lower bound computations for maximum matching and recording peaks in the resulting histogram of hits. The rationale behind this is that related schemas in the database have an overwhelming number of attributes semantically related to query attributes, so that indexing based on query attributes can only point to relevant matching schemas.

The method of searching schemas through matches in bipartite graphs is related to work on semantic schema matching, see “Semantic API Matching for Automatic Service Composition”, Caragea, D. and Syeda-Mahmood, T., Proceedings of the ACM WWW Conference, New York, N.Y., USA, June 2004, and to work on keyword-based schema search, see “Searching Databases for Semantically Related Schemas”, Shah, G. and Syeda-Mahmood, T., 27^{th} Annual ACM SIGIR, pp 504-505, Sheffield, England, UK, July 25^{th}-29^{th}, 2003. However, the methods disclosed in these papers do not carry out all the steps of the method of the present invention. As non-limiting examples, neither indexing, nor upper and lower bounds of computation, are discussed in these papers. These and other differences will become clear from the discussion that follows.

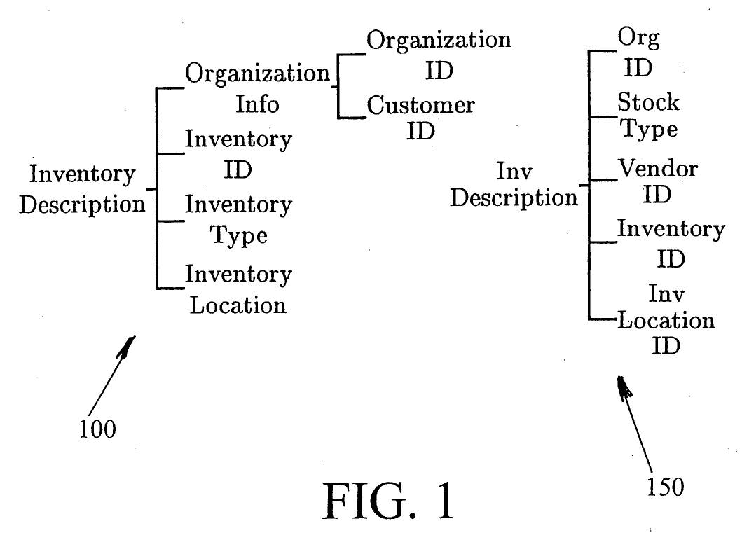

As in document retrieval, searching for matching schemas in XML repositories should be based on a notion of similarity rather than identical matches. However, the problem of searching schema repositories is considerably different from searching of large document repositories. Straight-forward information retrieval techniques that are based on frequency of occurrence of terms cannot be used directly as attributes from query schemas are much more likely to be found in many schemas rather than many times within a schema. In fact, it would be preferable if every query attribute were in a separate context uniquely accounted for in the matching schemas, unless there were cases where a single attribute was split across multiple attributes. Further, the semantics of the attributes have to be taken into account. This includes name semantics as well as type semantics. For example, FIG. 1 shows two similar schemas, 100 and 150, where 100 has attributes InventoryDescription, OrganizationInfo, InventoryID, InventoryType, InventoryLocation, OrganzationID and CustomerID, and 150 has attributes InvDescription, OrgID, StockType, VendorID, InevntoryID and InvLocationID. As shown in FIG. 1, matching schemas may not use exactly the same term to describe similar attributes (e.g. OrgID) versus OrganizationID, or StockType versus InventoryType). To find such similar terms, one would have to do at least word tokenization and part-of-speech tagging before nay thesaurus lookups could be made for synonymous words. Next, the type semantics are quite important in finding matchings, particularly for web service schemas. This ensures that operations match to operations, messages to messages, etc. Further, some degree of structural mismatching may have to be allowed as also seen in FIG. 1, where similar attributes are grouped differently in the schemas 100 and 150. This implies that XPath-like queries looking for precise placement of attributes in the schemas can be brittle. The size of the schemas should be an additional consideration. Imported schemas have to be resolved for repository schemas as well as query schemas before matching. Finally, to scale large repositories, indexing is essential, as is the case with document searching. However, when the schema is semantically guided, more information needs to be stored than just the schema addresses. In particular, other metadata such as token index, word index, type label, schema index, service index, etc. may have to be stored in the index.

Next, the relationship between schemas to be captured is described. Intuitively, as many as possible of the query attributes should match the repository schema attributes, with as few unmatched candidates as possible left on each side. Both the number and quality of the matching should be important so that the matching accounts for various notions of similarity between the attributes including similarity as to both name and type. All this can be achieved if the matching between the schemas can be modeled as the problem of computing a matching in a bipartite graph formed from the query and repository schema attributes. A matching of maximum cardinality as well as maximum weight is desired. To select the best matching schemas from the repositories then, the schemas are ranked based on a score of the matching normalized with respect to the sizes of the individual schemas.

More formally, consider a bipartite graph G=(V=X∪Y, E, C) where X∈Q and Y∈D are attributes of query and repository schemas Q and D respectively, E are the edges defining possible relationships between attributes, and C:E→R are the similarity scores representing similarity between query and schema attributes per edge. In this formalism, it is assumed that an edge is drawn between two attributes only if they are semantically related. A matching M⊂E is a subset of edges in E such that each node appears at most once. The size of the matching is indicated by |M|. For each repository schema, the desired matching is a matching of maximum cardinality |M| that also has the maximum similarity weight:
C(M)=ΣC(Eᵢ) (1)
where C (Eᵢ) is the similarity between the attributes related by the edge Eᵢ.

The ranking of a schema is then given by:
R₁(D)=2. |M_{D}|/(|Q|+|D|) (2)
where M_{D} is a maximum cardinality matching in the schema D. for schemas that have the same rank R₁, they are further ranked by:
R₂(D)=Cₘₐₓ(M_{D})/M_{D} (3)
where Cₘₐₓ (M_{D}) is the maximum similarity score associated with the maximum matching M_{D}.

In practice, all matchings that are above a threshold T are retained. The threshold can be chosen to maintain a proper balance between precision and recall.

Algorithms are available for computing maximum cardinality, maximum weight bipartite graph matching, see “An Efficient Cost Scaling Algorithm for the Assignment Problem”, Goldberg, Andrew V. and Kennedy, R., SIAM Journal on Discrete Mathematics, volume 6, number 3, pp 443-459, April 1993. This matching is computed by setting up a flow network with weights such that the maximum flow corresponds to a maximum matching. In general, finding a maximum matching of maximum weight is a computing intensive operation taking O (V E²) time, where V is the number of nodes and E the number of edges. Even with the best algorithm this can be a really slow operation, particularly as it needs to be repeated for all repository schemas. Consolidating all the attributes of all schemas into a huge bipartite graph will actually make this worse, as then both time and storage complexities must be dealt with.

To speed up the computation, it is first observed that as the first ranking is based upon the size of the matching alone, a simpler algorithm can be used to find only the maximum cardinality matching using a variant of the network flow algorithm, see “Introduction to Algorithms” by Thomas H. Cormen, Charles, E. Leiserson, and Ronald, L. Rivest, MIT Press, 1990. The maximum weight matching needs to be computed only for those cases where there is a tie in the ranking. As the purpose of the search is to identify candidate matchings, this second level ranking of schemas may not be needed.

The network flow algorithm, however, is also computationally intensive, particularly for graphs exceeding 100 or more attributes. To speed up the computation during the search, therefore, the size of the matching is estimated and the estimate is used to rank the schemas. Specifically, tight upper and lower bounds are derived on the size of the matching that can be quickly computed, and the bounds are used for ranking purposes.

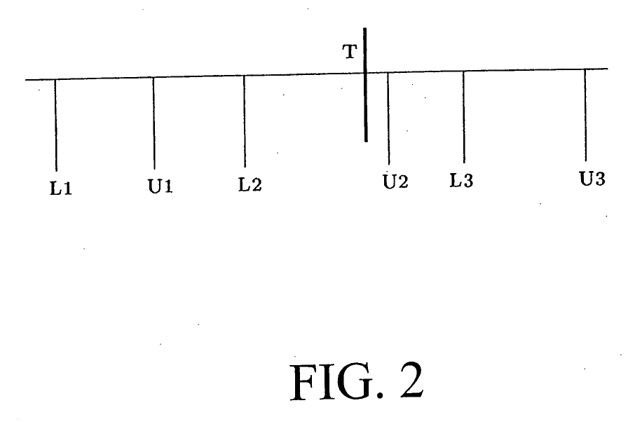

The rationale behind using the bounds is as follows: Suppose it is desired to retain only those schemas as matchings whose actual maximum matchings are of size at least T. Instead of computing the actual maximum matching, suppose (Lₛ, Uₛ) are the lower and upper bounds on the matching size computed for schema S. Then, if Lₛ<Uₛ<T (e.g. where Lₛ and Uₛ are L₁ and U₁, in FIG. 2) or Uₛ>Lₛ>T (e.g. where Lₛ and Uₛ are L₃ and U₃ in FIG. 2), then no errors are made by working with the bounds instead of the actual matching size, as shown in FIG. 2. On the other hand, if Lₛ<T<Uₛ as shown by L₂ and U₂ in FIG. 2, then this could lead to a false negative when the actual maximum matching is above T, even thought the lower bound is below T. This error can be minimized by choosing tight upper and lower bounds. In the next section, tight upper and lower bounds on the size of the maximum matching are derived, and it is shown that they can easily be computed.

In addition to the bounds, the value of the threshold T affects precision and recall. This threshold is chosen using a standard approach from information retrieval. Specifically, the threshold is varied and the average numbers of false positives and false negatives made during searching a large reference repository using a large number of test queries is recorded. The Receiver Operating characteristics (ROC) curve is plotted, and the threshold T that achieves the desired precision and recall is selected. Selecting the threshold in this manner ensures that for the majority of queries the search engine retrieves matchings meeting the specified precision and recall.

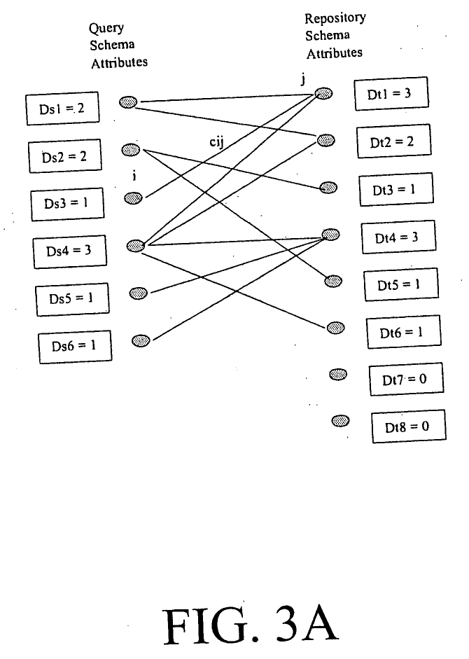

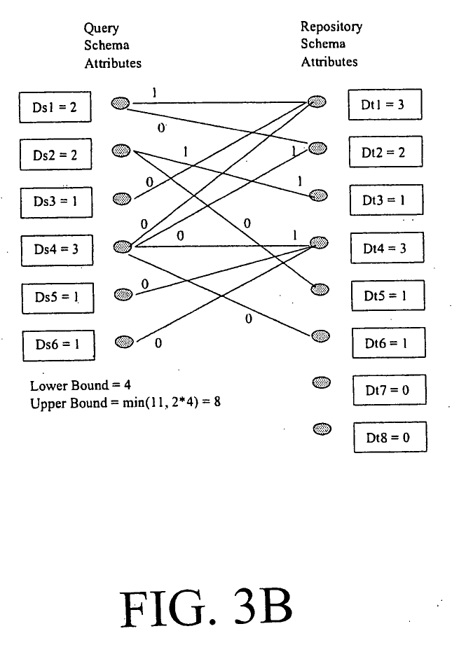

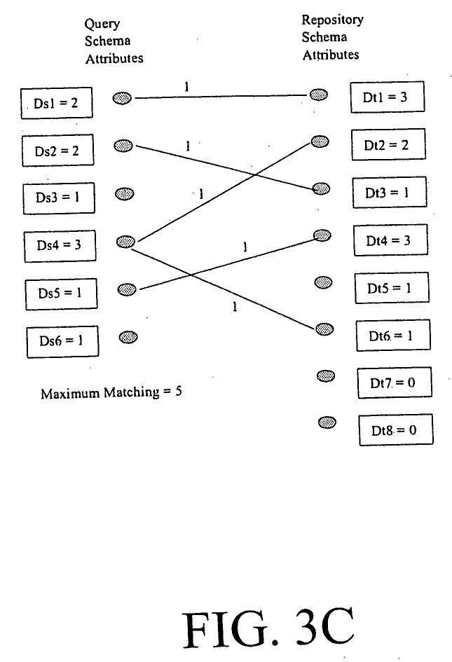

A bipartite graph between query and repository schema are shown in FIG. 3A, 3B and 3C. FIG. 3A illustrates an original bipartite graph of upper and lower bounds in maximum matching. FIG. 3B illustrates operations in lower bound computation, retaining only one outgoing or incoming edge per node. FIG. 3C illustrates the maximum matching for the graph of FIG. 3A. In these views, source attributes Ds1, Ds2, Ds3, Ds4, Ds5 and Ds6 are shown for the query schema, and target attributes Dt1, Dt2, Dt3, Dt4, Dt5, Dt6, Dt7 and Dt8 are shown for the repository schema.

Let Dₛᵢ be the degree of the i-th node in a query schema of N attributes, i.e. the number of edges incident on the node i. Let Dₜⱼ be the degree of the j-th node in the repository schema. Let aᵢⱼ be the edge between the two nodes. Let cᵢⱼ be the similarity score between the nodes i and j. Then modified scores c′ᵢⱼ and modified node degrees D′ₛᵢ are defined as:

$${c}_{ij}^{′} = \{ \begin{matrix}0 & if {∃}_{akj} , & k < I , & {c}_{kj}^{′} > 0 or {∃}_{akj} , & 1 < j , & {c}_{ij} > 0 \\ 1 & Otherwise & & & & \end{matrix} \\ and \\ {D}_{si}^{′} = \{ \begin{matrix}1 & if {∃}_{{c}^{′} ij} > 0 \\ 0 & Otherwise\end{matrix}$$

$${L}_{s} = {\sum }_{i = 1}^{N} {D}_{si}^{′}$$

is a lower bound on the size of the matching. In the graph induced by the above transformation, D′ defines a matching by itself, i.e. at most one edge is incident oh the node. Hence, the matching of maximum size is at least of size Lₛ. Lₛ is also the bound given by greedy methods of maximum matching computed by retaining at most one edge per node on a first come first served basis. Based on this computation, the lower bound on the matching computed for the bipartite graph in FIG. 3A, 3B and 3C is 4, whilst the actual maximum matching is of size 5.

$$Let {U}_{s} = min ( {\sum }_{i = 1}^{N} {D}_{si} , 2 * {L}_{s} \cdot {U}_{s}$$

is an upper bound on the size of the maximum matching. The first term is the sum total of the number of edges of the bipartite graph, and is clearly an upper bound of the size of the maximum matching. It is also well known in the art that the size of the maximum matching is less than or equal to twice the size of greedy matching. Thus Uₛ, being a minimum of the two terms, is a tight upper bound on the maximum matching.

Unlike O (V E²) computations required for maximum flow computations, the upper and lower bounds can be simply computed in O (|E|) time, as each edge in the graph need be examined only once. In fact, the following simple algorithm can be used to compute the lower bound.

Initialize all source and target nodes degrees as D′ₛᵢ←0, D′ₜⱼ←0

Initialize all cᵢⱼ←0

For all edges aᵢⱼ∈E Do
If D′ₛᵢ=0 and D′ₜⱼ=0 Then
C′ᵢⱼ←1
D′ₛᵢ←1
D′ₜⱼ←1

$$Lower bound = {\sum }_{i = 1}^{N} {D}_{si}^{′}$$

The upper bound can be obtained directly, once the lower bound has been computed. Knowing the upper bound helps in estimating the additional recall errors made by ranking the matchings based on the lower bounds instead of the exact matching size following the analysis given above.

The above method of searching through schemas is independent of the method used to determine the relationship between query and repository schema attributes. To ensure meaningful matchings, and to allow for situations where schemas use related but perhaps not identical words, and to describe related entities, both name and type semantics are used in modeling similarity between attributes.

Finding name semantics between attributes is difficult, in general, for the following reasons:

1. Query attributes could be multi-word terms (for example, CustomerIdentification, PhoneCountry) which require tokenization. Any tokenization must capture naming conventions used by database administrators, system integrators and programmers to form attribute names.

2. Finding meaningful matchings to a query attribute would need to account for the different senses of the word as well as its part-of-speech tag through a thesaurus.

3. Multiple matchings of a single query attribute to many database attributes and multiple matchings of a single database attribute to many query attributes must be taken into account.

Name semantics are captured using a technique similar to the one in “Corpus Based Schema Matching”, Madhavan, J., Bernstein, P. A., Chen, K., Halevy, A. and Shenoy, P., Proceedings of Information Integration On The Web, pp 59-66, Acapulco, Mexico, August 2003. Specifically, multi-term query attributes are parsed into tokens. Part-of-speech tagging and stop-word filtering is performed. Abbreviation expansion is done for the retained words if necessary, and then a thesaurus is used to find the ontological similarity of the tokens. The resulting synonyms are assembled back to determine matchings to candidate multi-term word attributes of the repository schemas. The details are described below.

Word tokenization: To tokenize words, common naming conventions used by database administrators and programmers are exploited. In particular, word boundaries in a multi-term word attribute are found using changes in font and presence of delimiters such as underscore, spaces and numeric to alphanumeric transitions. Thus, words such as CustomerPurchase will be separated in to Customer and Purchase. Address_{—}1, Address_{—}2 would be separated into Address, 1 and Address, 2 respectively. This allows for semantic matchings of the attributes.

Part-of-speech tagging and filtering: Simple grammar rules are used to detect noun phrases and adjectives. Stop-word filtering is performed using a pre-supplied list. Common stop words in the English language similar to those used in search engines have been used.

Abbreviation expansion: The abbreviation expansion uses domain—independent as well as domain-specific vocabularies. It is possible to have multiple expansions for candidate words. All such words and their synonyms are retained for later processing. Thus, a word such as CustPurch will be expanded into CustomerPurchase, CustomaryPurchase, etc.

Synonym search: The WordNet thesaurus was initially used to find matching synonyms to words and their tokens. See “WordNet: A Lexical Database for the English Language”, Miller, G. A., http://www.cogsci.princeton.edu/wn . However, the preferred thesaurus is Sureword by PatternSoft, Inc., see http://www.patternsoft.com/sureword.htm . Please note that any other suitable thesaurus could be used without departing from the scope of the invention. Each synonym was assigned a similarity score based on the sense index and the order of the synonym in the matchings returned.

Matching generation: Consider a pair of candidate matching attributes (A, B) from the query and repository schemas respectively. Let A, B have m and n valid tokens respectively, and let S_{yi} and S_{yj} be their exploded synonym lists based on ontological processing. Consider each token i in source attribute A to match a token j in destination attribute b if i∈S_{yi} or j∈S_{yj}. The semantic similarity between attributes A and B is given by:

$$Sem ( A , B ) + 2 \cdot \frac{Match ( A , B )}{m + n} \qquad ( 4 )$$

where Match (A, B) are the matching tokens based on the definition above. The semantic similarity measure allows matching of attributes such as (state and province), (Customerldentification and ClientCategory), etc.

Fortunately, for all schema attributes, a type definition is known. For example, in web service schemas, operation names are associated with operation type, part names are associated with XSD schema types, etc. In the current formulation, only simple type semantics are allowed, i.e. when two attributes have the same tag type. An exception to this rule is in web service schemas where matchings to part names from names with XSD schemas are allowed, as programmers sometimes ignore part names of messages as XSD types.

The search formulation discussed above gave an efficient way to estimate the size of the maximum matching given a bipartite graph between a pair of schemas. However, such a search mechanism would still require examining all pairs of query and repository schema attributes to determine if edges exist taking time

$$O ( N {\sum }_{i = 1}^{K} {P}_{i} )$$

where N is the number of query schema attributes, Pᵢ is the number of attributes in repository schema I, and K is the total number of repository schemas. For example, in a database of 500 schemas alone, a schema could have over 50 attributes, 2 to 5 tokens per attribute, and 5 to 30 synonyms per token, making a search for a query of 50 attributes easily around 50 million operations per query!

Indexing of the repository schemas is, therefore, crucial to reducing the complexity of the search. Specifically, if candidate attributes of the database schemas can be directly identified by computing a hash function of the query attributes, then the lower bound computation can proceed only on-the identified edges. This can reduce the search complexity from

$$O ( N {\sum }_{i = 1}^{K} {P}_{i} ) to O ( N ) ,$$

as the database attributes for each query attribute need to be looked up only once (which can be done in O (1) time!).

Attribute hashing will now be described, which is a semantic indexing scheme that allows determination of valid edges of the bipartite graph to allow fast lower bound computation.

Consider all attributes a extracted from the repository schemas. Let fᵢ be the features computed from the attribute aᵢ. In this case, the features are the synonyms per word token. Let Sᵢ represent all relevant indexing information corresponding to the attribute aᵢ that uniquely locates it in the repository. In this case, the relevant indexing information will include token indexing within a word, word indexing within a schema, and schema indexing within the repository. Let the set of all attributes that have the same features as fᵢ be represented as {aᵢ, aⱼ, aₖ . . . }, and let the corresponding indexing information be represented as {<aᵢ, Sᵢ>, <aⱼ, Sⱼ>, <aₖ, Sₖ> . . . }. Let h be a hash function that allows attributes with similar features to be grouped together. That is:
h(ƒᵢ)={<aᵢ, Sᵢ>, <aⱼ,Sⱼ>,<aₖ,Sₖ>, . . . } (5)
where all entries <a, S> correspond to attributes that have same features value fᵢ. The, given an attribute qᵢ for query schema, the matching attributes for repository schemas are obtained by computing the feature f_{q} and indexing using the hash function h(qₒ). The resulting set is filtered for false positives using a word token matching analysis. The retained attributes define the edges of the bipartite graph, whilst their corresponding schemas indicate possible matching schemas. Once edges are defined, the lower bound computation can proceed as normal.

The attribute hashing algorithm is given below:

1. For every query attribute term qᵢ on Q Do

A. For every term t_{c} associated with the query attribute qᵢ Do

Index hash table with key t_{c}, Let the entries be

H(t_{c}) = {O₁, O₂, ...}
For each tuple
Oⱼ = < tⱼ, Cₘⱼ, wₖ, bᵢ, Sₘ> Do

If (bᵢ=b_{α1})
{

If (t_{c} is an ontological term)

{// domain-dependent
// ontological match
If (D′(qᵢ)=0 and D′(wₖ)=0)

{

D′(qᵢ)=1
D′(wₖ)=1
Histₒₙₜ(Sₘ)=
Histₒₙₜ (Sₘ)+1

}

}
Else
{
//domain-independent match
semMatch (qᵢ, wₖ) [symbol] semMatch (qᵢ, wₖ)+1
Retain tuple Oᵢ
}

}

B. For each retained tuple

Oⱼ=<tⱼ, Cₘⱼ, Wₖ, bᵢ, Sₘ> normalize the semantic match scores based on the tokens as
semMatch (qᵢ, wₖ)←(2 semMatch (qᵢ, Wₖ))/(|qᵢ|+|Wₖ|)

Where |qᵢ | and |wₖ | are the number of tokens in the corresponding query and repository service attribute.

C.

If semMatch (qᵢ, Wₖ)<τ

{

If D(qᵢ) = 0 and D (wₖ) = 0
{

D(qᵢ) = 1
D(wₖ) = 1
Histₛₑₘ(Sₘ) = Histₛₑₘ (Sₘ) +1

}

} //end of step1.

2. Rank (Sₘ)=(2*Histₛₑₘ (Sₘ))/(|Q|+|Sₘ|)

3. Retain all schemas with Rank (Sₘ)>Γ

The next step is to combine the ideas of matching graphs, lower bound computations, and indexing, to describe the overall approach of a preferred embodiment of the present invention to searching schema repositories. As in conventional information retrieval methods, there is an off-line index creation process stage to create a semantic index of schemas. During retrieval, features are extracted form query schemas and used against the index to retrieve candidate schemas which are then ranked based on lower bounds on the matching size. The details are described below.

The first step in off-line index creation is to parse the metadata to crate the schemas. Different parsers are used based on the metadata types. For example am EMF model for XSD schemas is used to process XSD schemas. For web services, a similar EMF-based parser has been developed to extract all the data from a WSDL file as a WDSL schema. Relational schemas are similarly processed using a relational EMF model. The details of XSD, WSDL and relational schema specifications are all available in the literature. See, for example, “XML Schema Definition” at http://www.w3c.org/XML/Schema and “Web Services Description Language” at http://www.w3c.org/TR/wsd1.

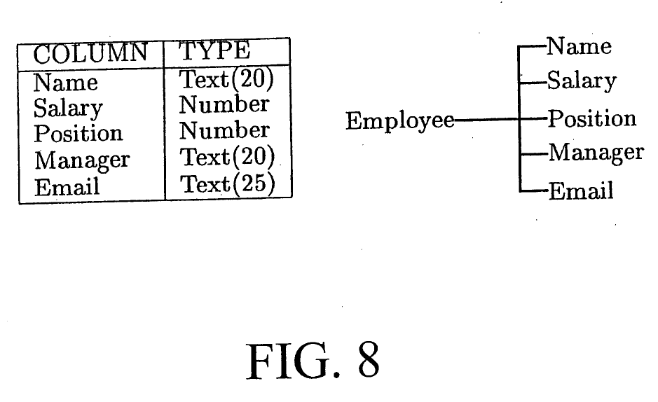

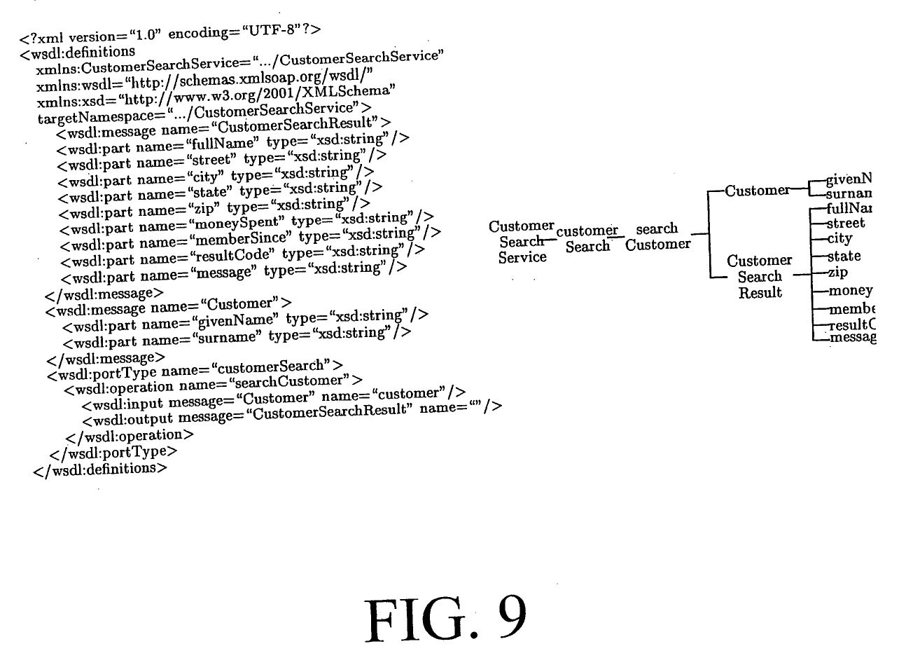

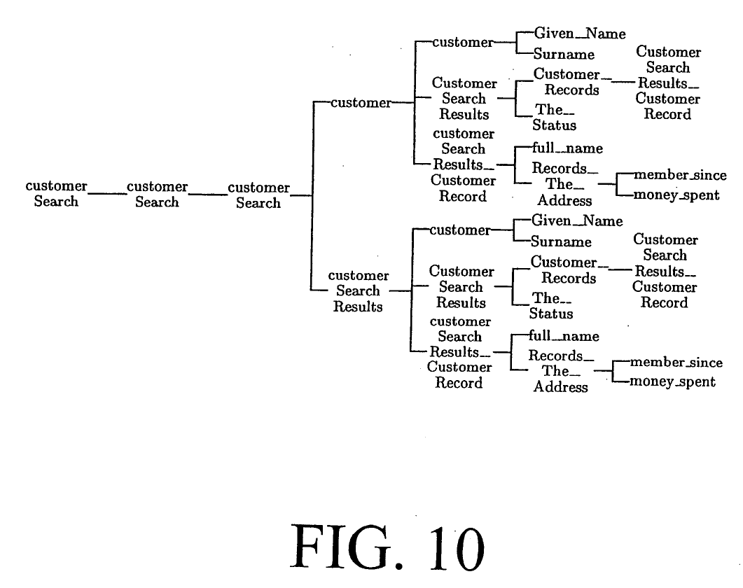

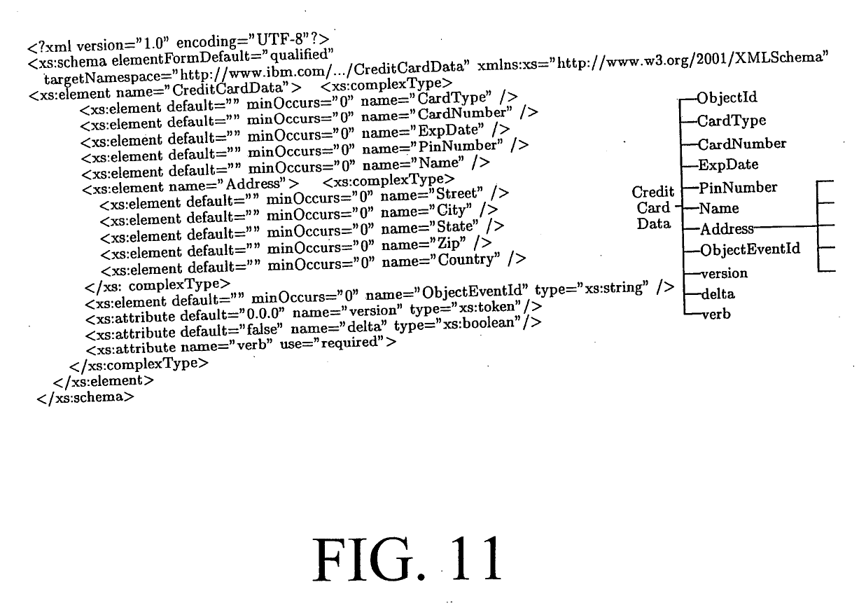

FIG. 8, 9, 10 and 11 show the conversion of each type of metadata into the corresponding schema. FIG. 8 illustrates sample relational database schemna. FIG. 9 illustrates sample WSDL schema. FIG. 10 illustrates matching WSDL schema. FIG. 11 illustrates sample XML schema.

To generate the schema from web services, we define each node as a tag type. The root is the name of the service and the next level represents portTypes. Each portType's child nodes correspond to operations. The parent-child relationship is determined, in general, by the scope of the tag. Thus, an operation has input and output messages as child nodes, whilst messages have parts as child nodes.

The parsers used to extract the schemas can also be used to extract word attributes along with their tag types. Multiple terms in each word are then separated into tokens as previously described, part-of-speech tagging and word expansions performed and synonyms per token derived using the WordNet thesaurus or the like. The synonyms are used as keys into the semantic hash table, which records the following tuple per indexed entry: <(tᵢ, wⱼ, t_{yj}, Sₖ)> where tᵢ is the index of the token, wⱼ the word attribute from which the token is derived, t_{yj} is the tag type of the word, and Sₖ is the schema from which the word attribute was extracted.

Query schemas are processed in a similar fashion to repository schemas except that no synonyms are looked up for the tokens of query attributes. Instead, the tokens are used directly to find matchings. This gives closer matchings than the matchings that would be obtained by looking up synonyms of synonyms. The resulting query tuples are denoted by <(tᵢ, qₘ, t_{ym})> where t₁ is the 1-th tuple in m-th query word attribute qₘ and t_{ym} is the type tag associated with query attribute qₘ.

The search algorithm extracts the word tokens for each attribute of the query schema and computes the semantic hash for each such token. It checks that the type tags of the hashed entries match, and updates the hit counts of the words from the schema repository. A semantic matching of a query word to a repository schema word is indicated if a large enough number of tokens find a matching to the repository schema word (a threshold τ=0.6667 is used, indicating that ⅔ of the query tokens need to match). When the words are found to be semantically related, the histogram of the schema hits is updated only if the degree counts of the corresponding attributes are 0 as described in the lower bound computation previously discussed. This ensures that each query word is accounted for only once in the matching repository schema. The resulting histogram is normalized to derive the schema rank as given by equation (2). This ensures that the best matching schemas have the largest number of one-to-one matches to query attributes, and are closest in size to the query schema as well.

If there are p schemas in the repository, Nᵢ attributes per schema i, tₖ tokens per word. and s_{y1} synonyms per token, then the time complexity of index creation is

$$O ( {\sum }_{i = 1}^{P} {\sum }_{k = 1}^{{N}_{i}} {\sum }_{l = 1}^{{t}_{k}} {S}_{{y}_{l}} ) .$$

As the number of tokens per word is small (≦5) and there are roughly 30 synonyms per word, the dominant terms in the indexing complexity are

$${\sum }_{i = 1}^{P} and {\sum }_{k = 1}^{{N}_{i}} .$$

On a 1 GB RAM machine, the entire database index for 570 schemas could be assembled in four minutes. The size of the semantic hash table depends on the number of synonyms and the number of words that are common across schemas. For that database sizes that have been tested (a total of 980 schemas), the semantic hash table Implemented as hash map can be stored in memory itself. However, as the size of the database grows, database index storage structures may have to be used. The complexity during search is O(|Q|.|N_{Q}|) where NQ are the number of tuples indexed per query word. For the databases tested, the search took fractions of a second per query.

The method of searching XML schemas has been tested on two large repositories. The first one was a business object repository consisting of 517 application-specific and generic business objects drawn from Crossworlds business object library designed for Oracle, Peoplesoft and SAP applications. The second repository was generated from 473 WSDL documents assembled from legacy applications such as COBOL copybooks and from the general services offered on http://www.xmlmethods.com. Each of the schemas was rather large, containing 100 or more attributes, particularly because of schema embedding through imports in web services or XSD documents, so that the fully-expanded schemas were rather large. The results for the XSD schemas are presented below.

The search performance was measured in relation to precision, recall and search time. The performance was also compared with two other techniques of searching schemas, namely full-text indexed searching and lexical matching searching. A full-text search engine for these repositories was made by creating an inverted index of all the words extracted from schemas and computing a histogram of schema hits using every query word to index the full-text index. Search performance against this search engine illustrates the effectiveness of graph matching over document retrieval type searching based on arguments presented above. The second method implemented is to illustrate the effectiveness f semantic search techniques over lexical matching methods. In this method the indexing and searching schemas remain the same, but the semantic name similarity comparison is replaced with a lexical similarity measure. Specifically, the extracted words from the schemas are not tokenized or word-expanded. Instead, they are directly compared with repository schema attributes using the following formula:

$$L ( A , B ) = 2 \cdot \frac{\vert LCS ( A , B ) \vert}{\vert A \vert + \vert B \vert}$$

Where A, B are the attributes, and LCS (A, B) is the longest common subsequence of A and B. The longest common subsequence can easily be obtained using dynamic programming, as explained in “Introduction to Algorithms” referred to above.

The kind of matchings produced using semantic searching of schemas is next illustrated using an example. FIG. 9 shows a query schema. The best matching schema retrieved from the repository is shown in FIG. 10. As can be seen, related items have been found even if the names are not identical (customerSearch versus SearchCustomer, given_name versus givenName, etc.), and their structural organization is not identical. In general, it was found that the semantic matching of attributes allows for term matchings when words are out of order, abbreviated, or have close meanings.

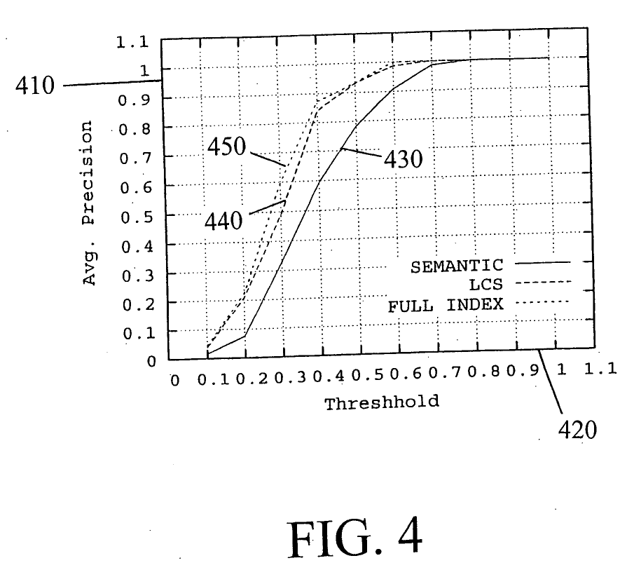

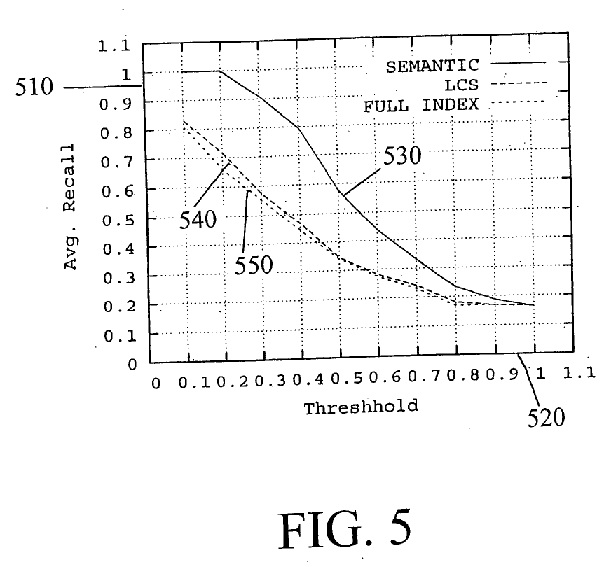

FIG. 4 and FIG. 5 show average precision and recall using three different methods of schema matching: full-text indexing, lexical matching and semantic matching according to a preferred embodiment of the present invention. In FIG. 4, average precision is plotted on the vertical scale 410 versus threshold on the horizontal scale 420, and three curves are shown, with semantic matching according to the present invention at 430, lexical matching at 440 and full-text indexing at 450. In FIG. 5, average recall is plotted on the vertical scale 510 versus threshold on the horizontal scale 520, and again three curves are shown, with semantic matching according to the present invention at 530, lexical matching at 540 and full-text indexing at 550.

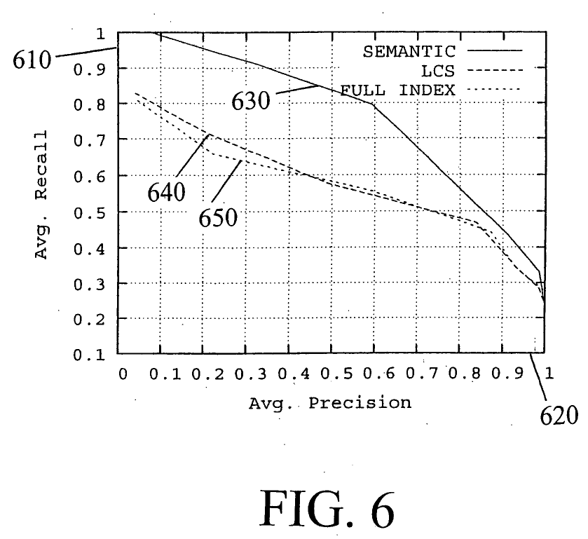

Experiments were run on twenty query schemas from the repository. For each query schema, the ideal matching schemas were manually selected from the whole database. Then the semantic matching algorithm of the present invention was run and the number of matching schemas was counted for each threshold value 0, 0.1, . . . 1.0. for comparison with full-text indexing and lexical matching, as many schema matchings were allowed as with the semantic matching, and then the average precision and recall were computed. It can be seen that the semantic matching does not perform as well as the other two methods for precision with lower thresholds, as it can match non-exact words. However, it demonstrates high recall at all thresholds and higher precision at higher thresholds. In FIG. 6 it can be seen that the semantic matching method of the present invention performs much better than full-text indexing and lexical matching in the precision versus recall graphs. In FIG. 6, average recall is plotted on the vertical scale 610 versus average precision on the horizontal scale 620, and three curves are shown, with semantic matching according to the present invention at 630, lexical matching at 640 and fill-text indexing at 650.

From this figure, an appropriate threshold for ranking can also be selected. For example, by choosing a threshold of T=0.4, 80% recall and 60% precision can be obtained using semantic matching.

The indexing performance of the hashing scheme was tested by noting the fraction of the database touched during the search. Using the semantic hash table, the complexity of the search was reduced significantly, as only matching tokens were explored. In fact, the experiments showed that, on average, a 90-95% reduction in searching time was achieved by the indexing step. The entire schema database consisting of over 100,000 total attributes indexed in less than two minutes on an Intel M-Pro 2 GHz Pentium, and matching schemas for queries were retrieved almost instantaneously. Table 1 shows the performance for sample query schemas. As can be seen, the matching schemas were in close agreement in the number of matching attributes. It should also be noted that only 3-5% of the database tokens were touched in the semantic hash table.

TABLE 1
Sample Query Schemas with Matchings from Database Schemas

| Source | Target | | | |
|---|---|---|---|---|
| Schema | Schema | Attributes | Used | Score |
| Address | BuyerAttributes | 26/26 | 3.98% | 0.8611 |
| | SupplierAttributes | 26/26 | | 0.8378 |
| | VendorAddress | 22/26 | | 0.7804 |
| | ServiceAddress | 22/26 | | 0.5714 |
| Customer | CustomerPartner | 264/269 | 5.49% | 0.9814 |
| | Site | 194/269 | | 0.7212 |
| | Vendor | 186/269 | | 0.6914 |
| | VendorPartner | 184/269 | | 0.6840 |
| Order | OrderLineItem | 259/298 | 5.55% | 0.8691 |
| | Trading Partner Order | 236/298 | | 0.7919 |
| | SAP OrderLineItem | 178/298 | | 0.5973 |

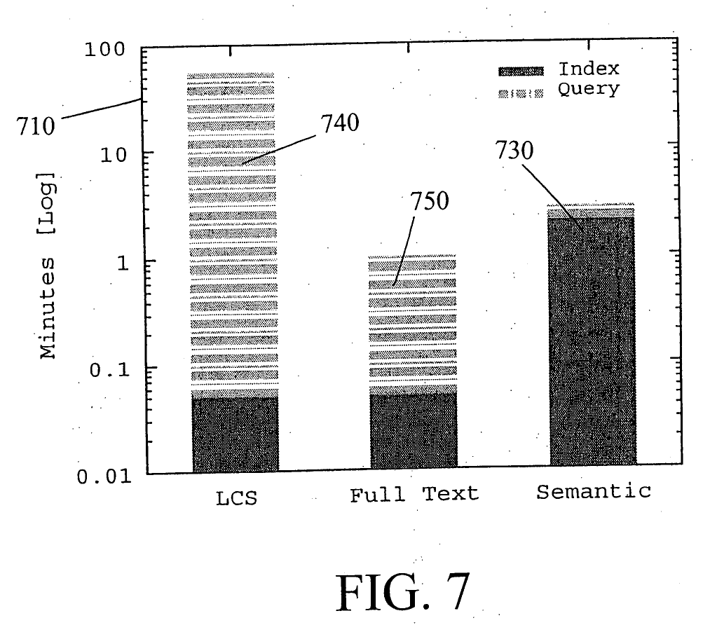

FIG. 7 also shows the time taken to run queries using three different methods. In FIG. 7, time in minutes is recorded on a logarithmic vertical scale 710, and three histograms are shown, with semantic matching according to the present invention at 730, lexical matching at 740 and full-text indexing at 750.

Time taken for indexing is shown as the solid part of each histogram, and time taken for the query is shown in the striped part. Note that indexing the database using semantic matching takes a long time but that this is a one-time requirement. Queries using semantic matching are much faster than queries using full-text indexing or lexical matching.

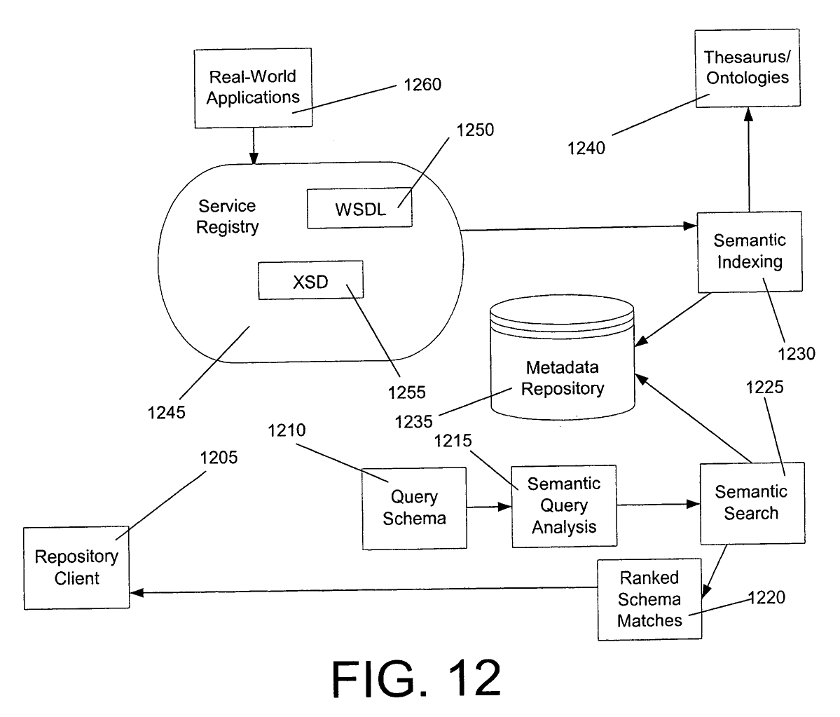

A system according to a preferred embodiment of the invention is shown in FIG. 12. Real-world applications 1260 such as Oracle, Siebel, SAP or Informatica communicate with a service registry 1245 that may contain WSDL documents 1250 and XSD documents 1255. Data from the service registry 1245 passes through semantic indexing means 1230 to metadata repository 1235 (e.g. XMeta). Semantic indexing means 1230 may employ a thesaurus or ontological data 1240. A query schema 1210 passes through semantic query analysis means 1215 to semantic search means 1225, and the result of the semantic search is recorded in metadata repository 1235 as well as being passed to repository client 1205 in the form of ranked schema matches 1220.

Searching through XML schema repositories for semantically related schemas has been described. In developing the search method, multiple requirements of schema searching were taken into account, including capturing of semantic relationships coupled with fast indexing mechanisms. Comparison with full-text search and lexical matching has shown that the semantic matching of the present invention outperforms the other methods in both precision and recall whilst keeping the search time comparable.

Additionally, the present invention provides for an article of manufacture comprising computer readable program code contained within implementing one or more modules to search repositories for semantically related schemas. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for: (a) word tokenization; (b) part-of-speech tagging and filtering; (c) abbreviation expansion; (d) synonym searching; and (e) matching generation.

### CONCLUSION

A system and method has been shown in the above embodiments for the effective implementation of a method and apparatus for semantic search of schema repositories. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of database programming.

What is claimed is:

1. A method of finding repository schema similar to a query schema in repositories of metadata via semantic search, comprising the steps of:
parsing said query schema to extract query words;
parsing at least one of said repository schema to extract repository words;
determining a match if a given proportion of said query words match a said repository word;
retaining each said repository schema in which at least one said match is found as a retained repository schema;
establishing a semantic matching for each said retained repository schema in which a given proportion of said query words matches a said repository word;
ranking each said semantic matching to determine a rank of said semantic matching; and
returning each said retained repository schema as a candidate if said rank of said semantic matching is greater than a predetermined value.

2. The method according to claim 1, wherein:
said step of ranking each said semantic matching further comprises the steps of:
finding a lower bound on said matching; and
ranking each said semantic matching based on said lower bound of said matching.

3. The method according to claim 2, further comprising the steps of:
generating a histogram of frequency of occurrence of said query words in each said retained repository schema; and
discarding said retained repository schema unless said retained repository schema corresponds to a maxima in said histogram.

4. The method according to claim 1, further comprising the steps of:
creating a hash table; and
indexing said hash table for each said query word.

5. The method according to claim 1, wherein:
said given proportion is substantially two thirds.

6. The method according to claim 1, further comprising, before said step of determining a match, the steps of:
tokenizing said query words;
tokenizing said repository words; and
extracting synonyms from said repository words by employing a thesaurus to expand said repository words.

7. The method according to claim 6, further comprising, the step of:
tagging parts of speech in said query words and said repository words.

8. A computer readable medium having computer executable instructions for performing steps to find repository schema similar to a query schema in repositories of metadata via semantic search, comprising:
computer readable program code parsing said query schema to extract query words;
computer readable program code parsing at least one of said repository schema to extract repository words;
computer readable program code determining a match if a given proportion of said query words match a said repository word;
computer readable program code retaining each said repository schema in which at least one said match is found as a retained repository schema;
computer readable program code establishing a semantic matching for each said retained repository schema in which a given proportion of said query words matches a said repository word;
computer readable program code ranking each said semantic matching to determine a rank of said semantic matching; and
computer readable program code returning each said retained repository schema as a candidate if said rank of said semantic matching is greater than a predetermined value.

9. The computer readable medium according to claim 8, wherein:
said computer readable program code ranking each said semantic matching further comprises:
computer readable program code finding a lower bound on said matching; and
computer readable program code ranking each said semantic matching based on said lower bound of said matching.

10. The computer readable medium according to claim 9, further comprising:
computer readable program code generating a histogram of frequency of occurrence of said query words in each said retained repository schema; and
computer readable program code discarding said retained repository schema unless said retained repository schema corresponds to a maxima in said histogram.

11. The computer readable medium according to claim 8, further comprising:
computer readable program code creating a hash table; and
computer readable program code indexing said hash table for each said query word.

12. The computer readable medium according to claim 8, wherein:
said given proportion is substantially two thirds.

13. The computer readable medium according to claim 8, further comprising:
computer readable program code tokenizing said query words;
computer readable program code tokenizing said repository words; and
computer readable program code extracting synonyms from said repository words by employing a thesaurus to expand said repository words.

14. The computer readable medium according to claim 13, further comprising:
computer readable program code tagging parts of speech in said query words and said repository words.

15. An apparatus for finding repository schema similar to a query schema in repositories of metadata via semantic search, comprising:
means for parsing said query schema to extract query words;
means for parsing at least one of said repository schema to extract repository words;
means for determining a match if a given proportion of said query words match a said repository word;
means for retaining each said repository schema in which at least one said match is found as a retained repository schema;
means for establishing a semantic matching for each said retained repository schema in which a given proportion of said query words matches a said repository word;
means for ranking each said semantic matching to determine a rank of said semantic matching; and
means for returning each said retained repository schema as a candidate if said rank of said semantic matching is greater than a predetermined value.

16. The apparatus according to claim 15, wherein:
said means for ranking each said semantic matching further comprises:
means for finding a lower bound on said matching; and
means for ranking each said semantic matching based on said lower bound of said matching.

17. The apparatus according to claim 16, further comprising:
means for generating a histogram of frequency of occurrence of said query words in each said retained repository schema; and
computer readable program code discarding said retained repository schema unless said retained repository schema corresponds to a maxima in said histogram.

18. The apparatus according to claim 15, further comprising:
means for creating a hash table; and
means for indexing said hash table for each said query word.

19. The apparatus according to claim 15, wherein:
said given proportion is substantially two thirds.

20. The apparatus according to claim 15, further comprising:
means for tokenizing said query words;
means for tokenizing said repository words; and
means for extracting synonyms from said repository words by employing a thesaurus to expand said repository words.

21. The apparatus according to claim 20, further comprising:
means for tagging parts of speech in said query words and said repository words.
